(19) United States
(12) Patent Application Publication
(10) Pub. No.: US 2010/0161419 A1
(43) Pub. Date: Jun. 24, 2010

(54) System and Method for Allocation and Pricing of Overlapping Impression Pools of Online Advertisement Impressions for Advertising Demand with Frequency Capping

(75) Inventor: John Anthony Tomlin, Sunnyvale, CA (US)

Correspondence Address: Mauriel Kapouytian & Treffert LLP, 151 1st Avenue, #23, New York, NY, 10003, US

(73) Assignee: Yahoo! Inc., Sunnyvale, CA (US)

(21) Appl. No.: 12/340,695

(22) Filed: Dec. 20, 2008

(51) Int. Cl. G06Q 30/00; G06Q 90/00

(52) U.S. Cl. 705/14.55; 705/14.73

(57) ABSTRACT

An improved system and method for allocating and pricing impression pools of advertisement impressions with frequency capping is provided. An upper bound on the number of impressions which an impression pool can supply to satisfy advertiser demand may be generated and used as a constraint to allocate impressions to satisfy advertiser requests. Either a deterministic upper bound may be generated or a stochastic upper bound may be generated on the number of impressions which an impression pool can supply to satisfy advertiser demand, and this upper bound may be used as a constraint to allocate impressions to satisfy advertiser requests for advertisement placements on the display advertising properties. In an embodiment, frequency caps, display frequencies, arrival rates of unique users, and departure rates of unique users may be used to compute the upper bounds on the number of impressions which an impression pool can supply to satisfy advertiser demand.

### FIELD OF THE INVENTION

The invention relates generally to computer systems, and more particularly to an improved system and method for allocation and pricing of overlapping impression pools of online advertisement impressions for advertising demand with frequency capping.

### BACKGROUND OF THE INVENTION

Traditionally, there are two common internet advertising market segments. One is the text advertisement segment, and the other is the banner segment. Text advertisements are generally segments of text that may be linked to the advertiser's web site via a hypertext link. The text advertisement business is mainly conducted through sponsored search auction and content match technologies. Content matching is a widely used mechanism for selling online advertising by matching advertisements to content published on the Internet. Each time a user requests published content, advertising space may be allocated within the content served in response to the user's request. For instance, page content may be aggregated into keywords, and advertisements may be matched to content using the highest payment offered by an advertiser for the keywords representing the content.

For the banner advertising segment, behavioral targeting technology has been used, where both users and advertisements are mapped into categories, and then advertisements with the highest payments offered by an advertisers that are in the same categories with a user will be served to that user. Unfortunately, the categories may be defined by marketing personnel relying on their experience, rather than by the interests of the users. Moreover, the categories may be defined in a hierarchy that may focus on vertical areas such as travel or shopping, and thus may unnecessarily restrict selection of an advertisement within a vertical, instead of considering the broader interests of the users and a representative sample of display properties for advertisers.

What is needed is a way to allocate and price advertisements that provides a representative sample of display properties for advertisers and takes into account limiting the number of times the same advertisement may be displayed to a unique user. Such a system and method should consider users' experience and interests to provide more relevant advertisements and should provide a representative sample of display properties for advertisers.

### SUMMARY OF THE INVENTION

The present invention provides a system and method for allocating and pricing of overlapping impression pools of online advertisement impressions for advertising demand. A frequency capping engine may be provided that generates frequency cap constraints for how many times a particular advertisement may be shown online to unique users. The frequency capping engine may be operably coupled to an allocation and pricing optimizer that allocates advertisement impressions from impression pools by maximizing an objective function with a number of constraints, including supply constraints, demand constraints, and frequency cap constraints. In an embodiment, the frequency capping engine may obtain frequency caps that indicate a limit to a number of times an advertisement impression may be displayed to a unique user to satisfy a request of an advertiser for advertisement placement of advertisements on display advertising properties, and the frequency capping engine may also obtain the frequency that each advertisement impression was displayed to unique users to satisfy the request of the advertiser for advertisement placement of advertisements on display advertising properties. The frequency capping engine may use the frequency caps and display frequencies to compute frequency cap constraints for advertisement impression from the impression pools that may satisfy advertiser requests for advertisement placements on display advertising properties.

In general, an upper bound on the number of impressions which an impression pool can supply to satisfy advertiser demand may be generated and used as a constraint to allocate impressions to satisfy advertiser requests. In an embodiment, a deterministic upper bound may be generated for each of the impression pools that may satisfy the requests for advertisement placements on the display advertising properties. In other embodiments, a stochastic upper bound may be generated by a compartmental model on the number of impressions which an impression pool can supply to satisfy advertiser demand, and this upper bound may be used as a constraint to allocate impressions to satisfy advertiser requests for advertisement placements on the display advertising properties. To do so, frequency caps for advertiser requests, display frequencies of advertisement impressions to unique users, arrival rates of unique users to display advertising properties, and departure rates of unique users from display advertising properties may be obtained and used to compute the upper bounds on the number of impressions which an impression pool can supply to satisfy advertiser demand. Advertisement impressions may then be allocated from impression pools by maximizing an objective function with a number of constraints, including supply constraints, demand constraints, and frequency cap constraints.

The present invention may be used by many applications for allocating and pricing of overlapping impression pools of online advertisement impressions for advertising demand with frequency capping. For example, online banner advertising applications may use the present invention to allocate online advertisement impressions that satisfy advertising demand with frequency capping. Or online content-match advertising applications may use the present invention to allocate online advertisement impressions for available advertising space displayed with content requested by a user. Similarly, advertising applications for email may use the present invention to allocate online advertisement impressions for available advertising space displayed with a message from an inbox requested by a user. For any of these online advertising applications, advertisement impressions may be allocated and priced from overlapping impression pools with frequency capping to satisfy advertising demand.

Other advantages will become apparent from the following detailed description when taken in conjunction with the drawings, in which:

### BRIEF DESCRIPTION OF THE DRAWINGS

FIG. 1 is a block diagram generally representing a computer system into which the present invention may be incorporated;

FIG. 2 is a block diagram generally representing an exemplary architecture of system components for allocating and pricing of overlapping impression pools of online advertisement impressions for advertising demand with frequency capping, in accordance with an aspect of the present invention;

FIG. 3 presents a flowchart generally representing the steps undertaken in one embodiment for allocating and pricing advertisement impressions from impression pools to advertiser requests that satisfy impression demand with frequency capping, in accordance with an aspect of the present invention; and

FIG. 4 is a flowchart generally representing the steps undertaken in one embodiment for generating an upper bound on the number of impressions which an impression pool can supply to an advertising request, in accordance with an aspect of the present invention.

### DETAILED DESCRIPTION

### Exemplary Operating Environment

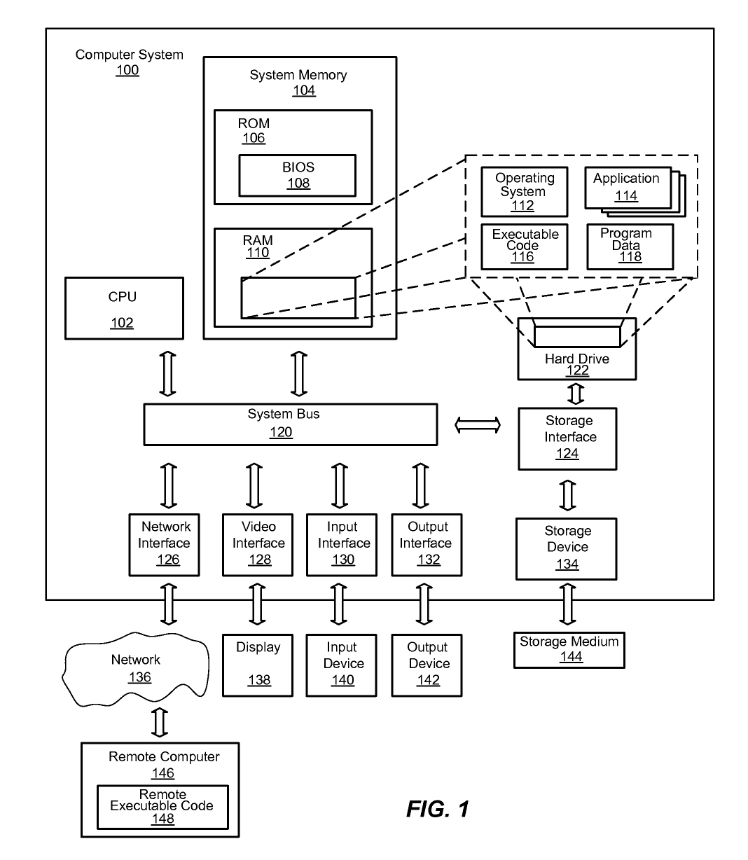

FIG. 1 illustrates suitable components in an exemplary embodiment of a general purpose computing system. The exemplary embodiment is only one example of suitable components and is not intended to suggest any limitation as to the scope of use or functionality of the invention. Neither should the configuration of components be interpreted as having any dependency or requirement relating to any one or combination of components illustrated in the exemplary embodiment of a computer system. The invention may be operational with numerous other general purpose or special purpose computing system environments or configurations.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention may include a general purpose computer system 100. Components of the computer system 100 may include, but are not limited to, a CPU or central processing unit 102, a system memory 104, and a system bus 120 that couples various system components including the system memory 104 to the processing unit 102. The system bus 120 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer system 100 may include a variety of computer-readable media. Computer-readable media can be any available media that can be accessed by the computer system 100 and includes both volatile and nonvolatile media. For example, computer-readable media may include volatile and nonvolatile computer storage media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer system 100. Communication media may include computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For instance, communication media includes wired media such as a wired network or direct-wired connection, and wireless media such as acoustic, RF, infrared and other wireless media.

The system memory 104 includes computer storage media in the form of volatile and/or nonvolatile memory such as read only memory (ROM) 106 and random access memory (RAM) 110. A basic input/output system 108 (BIOS), containing the basic routines that help to transfer information between elements within computer system 100, such as during start-up, is typically stored in ROM 106. Additionally, RAM 110 may contain operating system 112, application programs 114, other executable code 116 and program data 118. RAM 110 typically contains data and/or program modules that are immediately accessible to and/or presently being operated on by CPU 102.

The computer system 100 may also include other removable/non-removable, volatile/nonvolatile computer storage media. By way of example only, FIG. 1 illustrates a hard disk drive 122 that reads from or writes to non-removable, nonvolatile magnetic media, and storage device 134 that may be an optical disk drive or a magnetic disk drive that reads from or writes to a removable, a nonvolatile storage medium 144 such as an optical disk or magnetic disk. Other removable/non-removable, volatile/nonvolatile computer storage media that can be used in the exemplary computer system 100 include, but are not limited to, magnetic tape cassettes, flash memory cards, digital versatile disks, digital video tape, solid state RAM, solid state ROM, and the like. The hard disk drive 122 and the storage device 134 may be typically connected to the system bus 120 through an interface such as storage interface 124.

The drives and their associated computer storage media, discussed above and illustrated in FIG. 1, provide storage of computer-readable instructions, executable code, data structures, program modules and other data for the computer system 100. In FIG. 1, for example, hard disk drive 122 is illustrated as storing operating system 112, application programs 114, other executable code 116 and program data 118. A user may enter commands and information into the computer system 100 through an input device 140 such as a keyboard and pointing device, commonly referred to as mouse, trackball or touch pad tablet, electronic digitizer, or a microphone. Other input devices may include a joystick, game pad, satellite dish, scanner, and so forth. These and other input devices are often connected to CPU 102 through an input interface 130 that is coupled to the system bus, but may be connected by other interface and bus structures, such as a parallel port, game port or a universal serial bus (USB). A display 138 or other type of video device may also be connected to the system bus 120 via an interface, such as a video interface 128. In addition, an output device 142, such as speakers or a printer, may be connected to the system bus 120 through an output interface 132 or the like computers.

The computer system 100 may operate in a networked environment using a network 136 to one or more remote computers, such as a remote computer 146. The remote computer 146 may be a personal computer, a server, a router, a network PC, a peer device or other common network node, and typically includes many or all of the elements described above relative to the computer system 100. The network 136 depicted in FIG. 1 may include a local area network (LAN), a wide area network (WAN), or other type of network. Such networking environments are commonplace in offices, enterprise-wide computer networks, intranets and the Internet. In a networked environment, executable code and application programs may be stored in the remote computer. By way of example, and not limitation, FIG. 1 illustrates remote executable code 148 as residing on remote computer 146. It will be appreciated that the network connections shown are exemplary and other means of establishing a communications link between the computers may be used. Those skilled in the art will also appreciate that many of the components of the computer system 100 may be implemented within a system-on-a-chip architecture including memory, external interfaces and operating system. System-on-a-chip implementations are common for special purpose hand-held devices, such as mobile phones, digital music players, personal digital assistants and the like.

### Allocation and Pricing of Overlapping Impression Pools of Online Advertisement Impressions for Advertising Demand With Frequency Capping

The present invention is generally directed towards a system and method for allocating and pricing of overlapping pools of online advertisement impressions for advertising demand with frequency capping. An inventory of online advertisement impressions may be grouped in impression pools according to attributes of the advertisement impressions and advertisers' requests for impressions targeting specific attributes may be received. An upper bound on the number of impressions which an impression pool can supply to satisfy advertiser demand may be generated and used as a constraint to allocate impressions to satisfy advertiser requests. Either a deterministic upper bound may be generated or a stochastic upper bound may be generated on the number of impressions which an impression pool can supply to satisfy advertiser demand, and this upper bound may be used as a constraint to allocate impressions to satisfy advertiser requests for advertisement placements on the display advertising properties.

An optimal allocation and price may be computed for each of the impression pools of the inventory of online advertisement impressions using dual values from an optimization program that allocates advertisement impressions from impression pools with the frequency capping constraints.

As will be seen, frequency caps for advertiser requests, display frequencies of advertisement impressions to unique users, arrival rates of unique users to display advertising properties, and departure rates of unique users from display advertising properties may be used in an embodiment to compute the upper bounds on the number of impressions which an impression pool can supply to satisfy advertiser demand. As will be understood, the various block diagrams, flow charts and scenarios described herein are only examples, and there are many other scenarios to which the present invention will apply.

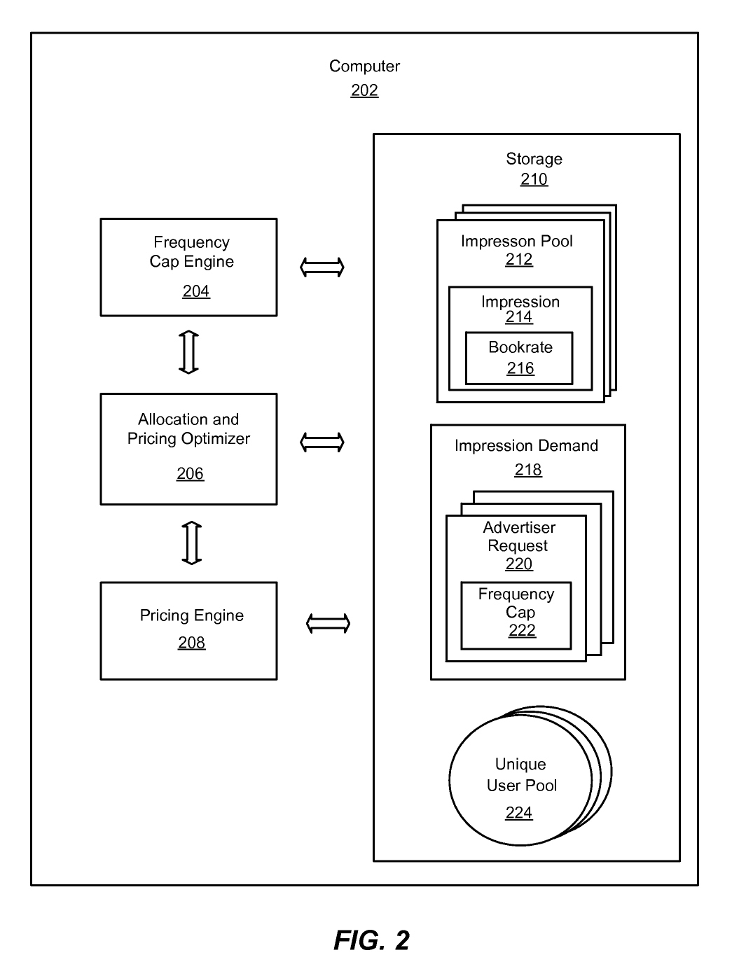

Turning to FIG. 2 of the drawings, there is shown a block diagram generally representing an exemplary architecture of system components for allocating and pricing of overlapping impression pools of online advertisement impressions for advertising demand with frequency capping. Those skilled in the art will appreciate that the functionality implemented within the blocks illustrated in the diagram may be implemented as separate components or the functionality of several or all of the blocks may be implemented within a single component. For example, the functionality of the pricing engine 206 may be implemented as a component within the allocation and pricing optimizer 204. Or the functionality of the pricing engine 206 may be implemented as a separate component from the allocation and pricing optimizer 204 as shown. Moreover, those skilled in the art will appreciate that the functionality implemented within the blocks illustrated in the diagram may be executed on a single computer or distributed across a plurality of computers for execution.

In various embodiments, a computer 202, such as computer system 100 of FIG. 1, may include a frequency cap engine 204, an allocation and pricing optimizer 206 and a pricing engine 208, each operably coupled to storage 210. The storage 210 may be any type of computer-readable storage media and may store impression pools 212 of advertisement impressions 214 with a book rate 216 that represents the price paid for the impression by an advertiser. As used herein, book rate may means a historical price paid for the advertisement impression. The storage 208 may also store impression demand 218 of advertiser requests 220 with a frequency cap 222 indicating how many times the same advertisement impression may be shown to unique users which may be grouped in one or more unique user pools 224.

The frequency cap engine 204 may generate constraints for how many times the same advertisement from a single pool of inventory may be shown to a pool of unique users 224. In an embodiment, a compartmental model may be used to generate a set of bounds that may be incorporated in an inventory allocation and pricing optimizer 204 that allocates advertisement impressions from impression pools to advertiser requests with frequency capping.

The allocation and pricing optimizer 206 may allocate advertisement impressions 214 from impression pools 212 to advertiser requests 220 to satisfy impression demand 218. The allocation and pricing optimizer 206 may solve linear or nonlinear programming models that may be determined by an objective function such as a distance or representativeness function which may be linear or nonlinear, including quadratic or log-linear functions. In an embodiment, the allocation and pricing optimizer 206 may produce a primal solution for an optimization program to allocate advertisement impressions 214 to advertiser requests 220. Additionally, the allocation and pricing optimizer 206 may produce a dual solution for the optimization program of values that may be used by the pricing engine 208 for pricing advertisement impressions allocated by the primary solution. Using values generated by the allocation and pricing optimizer 206, the pricing engine 208 may price allocated advertisement impressions 214 from impression pools 212 to advertiser requests 220 that satisfy impression demand 218. In an embodiment, the pricing engine 208 may use dual values associated with supply constraints from a primal solution of an optimization program applied to allocate advertisement impressions 214 to advertiser requests 220. Each of these components may be any type of executable software code that may execute on a computer such as computer system 100 of FIG. 1, including a kernel component, an application program, a linked library, an object with methods, or other type of executable software code. Each of these components may alternatively be a processing device such as an integrated circuit or logic circuitry that executes instructions represented as microcode, firmware, program code or other executable instructions that may be stored on a computer-readable storage medium. Those skilled in the art will appreciate that these components may also be implemented within a system-on-a-chip architecture including memory, external interfaces and an operating system.

There may be many applications which may use the present invention for allocating and pricing of overlapping impression pools of online advertisement impressions for advertising demand with frequency capping. For example, online banner advertising applications may use the present invention to allocate online advertisement impressions that satisfy advertising demand with frequency capping. Or online content-match advertising applications may use the present invention to allocate online advertisement impressions for available advertising space displayed with content requested by a user. Similarly, advertising applications for email may use the present invention to allocate online advertisement impressions for available advertising space displayed with a message from an inbox requested by a user. For any of these online advertising applications, advertisement impressions may be allocated and priced from overlapping impression pools with frequency capping to satisfy advertising demand.

In general, an upper bound on the number of impressions which an impression pool can supply to an advertiser demand may be generated and used as a constraint to allocate impressions to satisfy advertiser requests. In an embodiment, the inventory of impressions may be grouped and organized into impression pools by a set of attributes. A set of attributes may be any combination of one or more attributes associated with web page display properties, with web browser properties, with one or more users including demographics, online behavior, and so forth. Each impression pool may represent a disjoint set of attributes. For example, the set of attributes for an impression pool may include males between the ages of 20 and 30 living in the U.S. While each of the impression pools may represent a disjoint set of attributes, an inventory impression may belong to two or more impression pools, in which case the impression pools may be considered to overlap with one another. For instance, advertisement impressions in an impression pool that includes an attribute of “male” may also occur in another impression pool that includes an attribute of “living in the U.S.” Thus, the impression pools of impressions may be referred to as “overlapping.”

An Internet advertising service may receive numerous requests from advertisers. Each of these requests may identify a specific number of impressions that are desired that satisfy a particular set of attributes and may also include a frequency cap indicating the number of times the same advertisement may be shown to a unique user. For instance, an advertiser may request that the Internet advertising service provide a million impressions targeted to males with a frequency cap of 10. An Internet advertising service has a number of options available to it to satisfy such a request, since there may be a number of disjoint impression pools that include the attribute of “male.” For example, the males may be living in the U.S. or outside the U.S., as well as within various age ranges. As a result, there are a number of different ways that the Internet advertising service may satisfy this request from the different disjoint impression pools that include the attribute of “male.”

Consider the indices of the disjoint impression pools to be denoted by i=1, . . . ,I, and sᵢ to denote size of the disjoint impression pool i. The expected future value of inventory in disjoint pool i may be denoted by Vᵢ. Also consider the indices of the requested inventory sets to be denoted by j=1, . . . ,J, and dⱼ to denote the aggregate requested volume for demand profile j. An allocation of impression pools that may supply the requested volume for requested inventory sets may be optimized in any number of ways. Consider the set of impression pools which can supply demand j to be denoted by Sⱼ, and the set of demands which can be supplied by pool i to be denoted by S̅ᵢ. An allocation of impression pools that may supply the requested volume for requested inventory sets may be optimized for an Internet advertising service by maximizing the total value of unused inventory. In this case, such an objective function may be to maximize ΣᵢVᵢyᵢ subject to the supply constraints,

$${\sum }_{j ∈ {\overline{S}}_{i}}^{ } {x}_{ij} + {y}_{i} = {s}_{i} ∀ i = 1 , … , I ,$$

the demand constraints,

$${\sum }_{i ∈ {S}_{j}}^{ } {x}_{ij} = {d}_{j} ∀ j = 1 , … , J ,$$

and frequency cap constraints xᵢⱼ≦uᵢ·fⱼ, where yᵢ denotes unused inventory in pool i, where xᵢⱼ denotes the volume of impression pool i inventory assigned to request(s) for inventory type j, and where uᵢ denotes unique user i and fⱼ denotes the frequency cap for advertising request j.

Or an allocation may be optimized for advertisers by allocating a representative sample of inventory for each advertiser. In this case, an objective function may be to maximize an entropy function

$$E = - {\sum }_{i , j}^{ } {x}_{ij} ln ( {x}_{ij} ) ,$$

also subject to the supply constraints,

$${\sum }_{j ∈ {\overline{S}}_{i}}^{ } {x}_{ij} + {y}_{i} = {s}_{i} ∀ i = 1 , … , I ,$$

the demand constraints,

$${\sum }_{i ∈ {S}_{j}}^{ } {x}_{ij} = {d}_{j} ∀ j = 1 , … , J ,$$

frequency cap constraints xᵢⱼ≦uᵢ·fⱼ.

Or an allocation may be optimized to meet both objectives in an embodiment. In this case, an objective function may be a weighted composite of maximizing the cost of unused inventory and a proportional allocation of a set of impression pools which can supply demand k that may provide a representative sample of available inventory for advertisers. For example, the objective function may be to maximize

$${\sum }_{i} {V}_{i} {y}_{i} - γ {\sum }_{i , j} {x}_{ij} ln ( {x}_{ij} ) ,$$

subject to the supply constraints,

$${\sum }_{j ∈ {\overline{S}}_{i}} {x}_{ij} + {y}_{i} = {s}_{i} ∀ i = 1 , … , I ,$$

the demand constraints,

$${\sum }_{i ∈ {S}_{j}} {x}_{ij} = {d}_{j} ∀ j = 1 , … , J ,$$

and frequency cap constraints xᵢⱼ≦uᵢ·fⱼ. In various embodiments that may ensure representative allocation relative to some pre-defined allocation xⱼₖ₀, the objective function may be to maximize

$${\sum }_{i} {V}_{i} {y}_{i} - γ {\sum }_{i , j} [ {( {x}_{ij} - {x}_{ijo} )}^{2} / 2 {x}_{ijo} ] ,$$

where

$${x}_{ij 0} = \frac{{s}_{i} {d}_{j}}{{\sum }_{i : {\overline{S}}_{i} ⊆ {S}_{j}} {S}_{i}} ∀ i$$

such that S̅ᵢ⊂Sⱼ. Such an objective function may be a weighted composite of maximizing the cost of unused inventory while providing a proportional allocation of a set of impression pools which can supply demand k and may be described in further detail by copending U.S. patent application Ser. No. 12/125,877, entitled “FAIR ALLOCATION OF OVERLAPPING INVENTORY”.

Any of these objective functions for allocating inventory from impression pools subject to demand, supply and frequency cap constraints may be computed using a linear or nonlinear programming model. An optimizer, for instance, may apply non-linear programming to allocate advertisement impressions to advertiser requests for any of the objective functions described above with the demand, supply and frequency cap constraints. Those skilled in the art will appreciate that a dual values associated with supply constraints from a primal solution of an optimization program applied to allocate advertisement impressions may be used to compute an optimal price for each of the impression pools. An allocation and pricing optimizer, for instance, may apply a non-linear program to allocate advertisement impressions for an objective functions and extract values of the dual variable of the supply constraint from the non-linear program solution. The extracted values of the dual variable for prices of impression pools on the supply constraints may be iteratively set to be at least equal to the floor or book rate value and increased on those impression pools which have a dual value greater than the book rate value. Accordingly, optimal prices for impression pools may be set when the marginal value of one or more pools of inventory are greater than the book rate price.

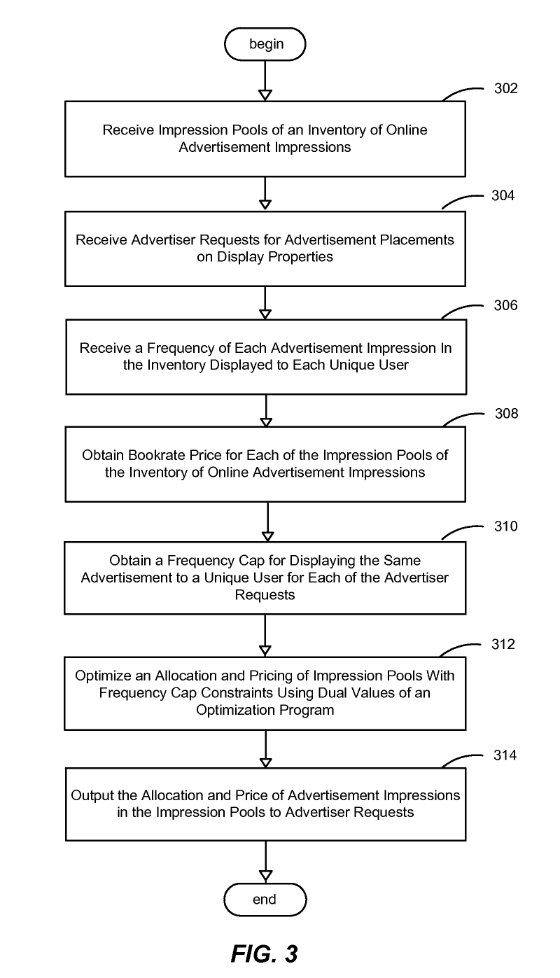

FIG. 3 presents a flowchart generally representing the steps undertaken in one embodiment for allocating and pricing advertisement impressions from impression pools to advertiser requests that satisfy impression demand with frequency capping. At step 302, impression pools of an inventory of online advertisement impressions may be received. In an embodiment, the advertisement impressions may be grouped in impression pools according to attributes of the advertisement impressions. For instance, the impression attributes may include web page attributes, user attributes, web browser attributes and so forth. Requests for advertisement placements on display advertising properties may be received at step 304. As used herein, a display advertising property may mean a collection of related web pages that may have advertising space allocated for displaying advertisements. In an embodiment, the impression demand of advertiser requests for impressions targeting specific attributes may be received.

At step 306, the frequency of each advertisement impression in the inventory that was displayed to each unique user may be received. At step 308, a book rate price may be obtained for each of the impression pools of the inventory of online advertisement impressions. A frequency cap for displaying the same advertisement to a unique user may be obtained at step 310 for each of the advertiser requests. In an embodiment, the frequency cap may be used to generate an upper bound on the number of impressions which an impression pool can supply to an advertising request and this upper bound may be represented as frequency cap constraint for an optimization program.

An optimal allocation and pricing may then be computed at step 312 for each of the impression pools of the inventory of online advertisement impressions using a dual variable of an optimization program with frequency cap constraints. In an embodiment, the values of the dual variable for prices of impression pools on the supply constraints may be extracted and iteratively set to be at least equal to the floor or book rate value and increased on those impression pools which have a dual value greater than the book rate value. And the optimal allocation and price computed for advertisement impressions in the impression pools of the inventory of online advertisement impressions with frequency cap constraints may be output at step 314.

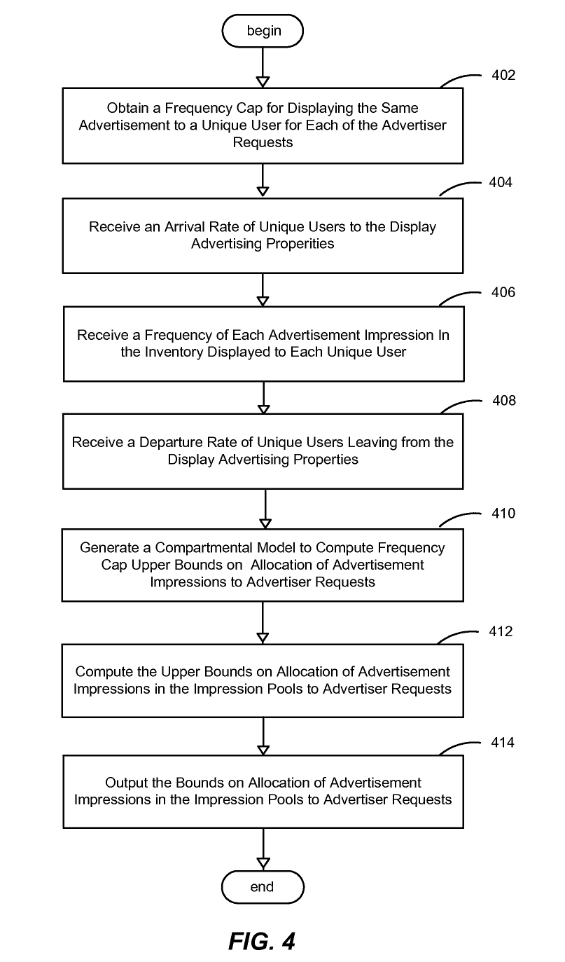

FIG. 4 presents a flowchart generally representing the steps undertaken in one embodiment for generating an upper bound on the number of impressions which an impression pool can supply to an advertising request. An advertisement impression in an impression pool may be modeled as unique users arriving at a display advertising properties over the time horizon of the model. Given a forecast of the number of unique users visiting the display advertising properties which may be represented by uᵢ, and the frequency cap for booking an advertisement impression for demand j which may be represented by fⱼ, then the upper bound, xᵢⱼ≦uᵢ·fⱼ, may be placed as a constraint on the amount of inventory from impression pool i that can be used to satisfy advertiser demand for booking j. However this upper bound may be too optimistic, since it takes no account of the servability of the allocation.

In a simplified model where the unique users targeted by an advertiser can be considered as belonging to a single source or pool, the online advertising system may be represented by one user pool, and one advertiser, with a frequency cap of K. After unique users have been shown the advertisement K times, they must leave the system in this simplified model. They may also voluntarily choose to leave the system permanently. Such a simplified model may be formulated as a compartmental model, involving the arrival rate of users entering the system, the migration rate at which users in set k are shown the advertisement, and the rate at which users in set k spontaneously leave the system. At step 402, a frequency cap for displaying the same advertisement to a unique user may be obtained for each advertising request. An arrival rate of unique users to the display advertising properties may be received at step 404. The frequency that each advertisement impression is displayed to each unique user may be received at step 406. A departure rate of unique users leaving the display advertising properties may be received at step 408.

A compartmental model may then be generated at step 410. The components of the compartmental model may be defined as follows. Denote the sets of users in the system that have been shown the advertisement k times to be k=0,1, . . . , K−1, and consider xₖ to denote the number of users in the system that have been shown the advertisement k times. Also consider aₒ to denote the arrival rate of users entering the system, bₖ to denote the rate at which users in set k are shown the advertisement, and cₖ to denote the rate at which users in set k spontaneously leave the system.

An inflow equation such as

$$\frac{d {x}_{0}}{d t} = {a}_{0} - ( {b}_{0} + {c}_{0} ) {x}_{0}$$

may model inflow into the system. And a balance equation such as

$$\frac{d {x}_{k}}{d t} = {b}_{k - 1} {x}_{k - 1} - ( {b}_{k} + {c}_{k} ) {x}_{k}$$

may model balance of the system from time step t−1 to t. Considering that aₒ, bₖ and cₖ may be constants in an embodiment, the flows in this model can be estimated from data on the number of unique users for the display advertising properties who have seen the advertisement k times. The flows for such a model may be formulated in matrix terms as

$$\frac{d x}{d t} = Ax + f , where {r}_{k} = - ( {b}_{k} + {c}_{k} ) , \\ A = ( \begin{matrix}{r}_{0} & & & \\ {b}_{0} & {r}_{1} & & \\ & & … & \\ & & {b}_{k - 2} & {r}_{k - 1}\end{matrix} ) and f = {( {a}_{0} , 0 … , 0 )}^{T} .$$

The number of users arriving in the model may be denoted by aₒT, where T is the length of the time period in question, and the number of users having seen the advertisement the K^{th} time that leave in the model due to frequency capping may be denoted by bₖ₋₁xₖ₋₁T. Given each user in bucket k has seen the advertisement k times, the solution values xₖ and the total number of times the advertisement may be seen by users in the system at time T may be computed by

$$U = {\sum }_{k = 1}^{K - 1} {kx}_{k} + {b}_{k - 1} {x}_{k - 1} T .$$

Because this model assumes no contention for the unique users in the source pool, U represents an upper bound on the number of impressions which the pool can supply to the advertiser request, which may be expected to be tighter than the upper bound, xᵢⱼ≦uᵢ·fⱼ. The allocations xᵢⱼ may then be bound by xᵢⱼ≦min(uᵢ·fⱼ, U).

Assuming that A is constant and the eigenvalues of A, r₀, . . . , r_{K-1}, are unique, the eigensystem of A may be represented as AV=VR, where R=diag (r₀, . . . ,r_{K-1}). Consider column Vⱼ of V to be the j^{th} eigenvector of A, corresponding to the j^{th} eigenvalue rⱼ, and Vᵢⱼ to be defined as follows:

$${V}_{ij} = \{ \begin{matrix}0 & i < j , \\ {\prod }_{k = i + 1}^{K - 1} ( \frac{{r}_{j} - {r}_{k}}{{b}_{k - 1}} ) & j \leq i < K - 1 \\ 1 & i = K - 1.\end{matrix}$$

A fundamental matrix Φ=Φ(t) may be found that satisfies

$$\frac{d Φ ( t )}{d t} = A Φ ( t ) ,$$

Φ(0)=I such as Φ=Ve^{Rt}V⁻¹ in an embodiment. Given an initial condition x(0)=x⁰, then x(t)=Φx⁰. And the solution to

$$\frac{d x}{d t} = Ax + f$$

may be obtained to be x(t)=Φx⁰+∫₀^{t}Φ(t−s)f(s)ds. Assuming f(s) is a constant f, this reduces to: x(t)=Φx⁰+VR⁻¹[e^{Rt}−I]V⁻¹f. Since V may be of quite small dimension and triangular, V⁻¹f may be computed in an embodiment as the solution to Vy=f. Observe that V⁻¹ may be expressed in analytic form using Vᵢⱼ.

In various embodiments, bₖ and cₖ may not be assumed to be constants, but bₖ and cₖ may be functions of x(t). In these embodiments, it is reasonable to expect that the probability of an advertisement being shown to some user in set k would be proportional to the number of users in the set so that bₖ=αxₖ for some value α, and that

$$\frac{d {x}_{0}}{d t} = {a}_{0} - α {x}_{0}^{2} - {c}_{0} {x}_{0} and \frac{d {x}_{k}}{d t} = α [ {x}_{k - 1}^{2} - {x}_{k}^{2} ] - {c}_{k} {x}_{k}$$

for k=1, . . . , K−1. Observe this has the advantage that only the α value needs to be empirically determined, rather than all the bₖ values.

An iterative approach such as that proposed in Chapter 3 of R. Bellman, Stability Theory of Differential Equations, Dover Edition (1969) may be adopted to solve the ordinary differential equations (ODEs). In general, the iterative approach may begin by choosing some plausible or historical values of the xₖ and α which may be used to compute initial values of bₖ⁽⁰⁾ to solve the linearized system of ODEs and obtain a solution xₖ⁽¹⁾. New bₖ⁽¹⁾ values may then be computed and the process may iterate to find solutions for xₖ until a convergence threshold is satisfied. Experiments with small but realistic systems where K=4 or 5, holding the cₖ constant, show quite rapid convergence.

The cₖ coefficients that denote the rate at which users in set k spontaneously leave the system may also be estimated from the number of unique users in the “exposure classes”, that is, empirically observed numbers of non-returning unique users who have seen the advertisement a certain number of times. It is reasonable to assume that the rate at which users in set k spontaneously leave the system increases with the number of times a user has visited the display advertising property. Further assuming this to be linear, the rate at which users in set k spontaneously leave the system may be denoted in an embodiment by cₖ=k.βγ. By plugging this expression into

$$\frac{d {x}_{0}}{d t} = {a}_{0} - α {x}_{0}^{2} - {c}_{0} {x}_{0} and \frac{d {x}_{k}}{d t} = α [ {x}_{k - 1}^{2} - {x}_{k}^{2} ] - {c}_{k} {x}_{k}$$

for k=1, . . . , K−1, the differential equations

$$\frac{d {x}_{0}}{d t} = {a}_{0} - α {x}_{0}^{2} - γ {x}_{0} and \frac{d {x}_{k}}{d t} = α [ {x}_{k - 1}^{2} - {x}_{k}^{2} ] - ( k . β + γ ) {x}_{k}$$

may be obtained. An iterative process may be used to solve these ordinary differential equations.

Those skilled in the art will appreciate that refinements may be made to these embodiments, including modeling the arrival rate aₒ as a smooth function aₒ(t) so that f is no longer constant. In this case, more general techniques such as well-known numerical methods may be employed to compute x(t) such as numerical procedures for integration.

Returning to FIG. 4, the compartmental model generated may then be used at step 412 to compute upper bounds on allocation of advertisement impressions in the impression pools to satisfy advertiser requests. And at step 414, the upper bounds computed on the allocation of advertisement impression in the impression pools may be output. In an embodiment, the upper bounds computed may be a set of inequalities that provide a frequency cap constraints for an optimization program that allocates and prices pools of online advertisement impressions for advertising demand with frequency capping.

Thus the present invention may generate and apply frequency cap constraints in an optimization program to allocate and price advertisement impressions for an objective function. In an embodiment, a deterministic upper bound may be generated using a simple model for how many times a particular advertisement may be shown online to unique users. In various other embodiments, a stochastic upper bound may be generated using a compartmental model for how many times a particular advertisement may be shown online to unique users. Moreover, the present invention may incorporate frequency capping in any inventory allocation model using only upper bounds of the frequency cap constraints on the allocation. Importantly, the present invention may allocate and price advertisement impressions for impression pools using any well-behaved objective function subject to supply constraints, demand constraints and frequency cap constraints.

As can be seen from the foregoing detailed description, the present invention provides an improved system and method for allocating and pricing advertisement impressions from impression pools to advertiser requests that satisfy impression demand with frequency capping. Impression pools of the inventory of online advertisement impressions may be received and advertiser requests for advertisement placements on display advertising properties may be received. The frequency of each advertisement impression in the inventory that was displayed to each unique user and a frequency cap for displaying the same advertisement to a unique user may be received. In an embodiment, an upper bound on the number of impressions which an impression pool can supply to an advertising request may be generated as a frequency cap constraint for an optimization program. An optimal allocation and pricing may be computed for each of the impression pools of the inventory of online advertisement impressions using a dual variable of an optimization program with frequency cap constraints. And the optimal allocation and price computed for advertisement impressions in the impression pools of the inventory of online advertisement impressions with frequency cap constraints may be output. Advantageously, the system and method of the present invention may be generally applied to any well-behaved objective function subject to supply, demand and frequency cap constraints for allocating impression pools of advertisements that satisfy advertisers' demands. As a result, the system and method provide significant advantages and benefits needed in contemporary computing, and more particularly in online advertising applications.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A computer system for allocating online advertising, comprising:
a frequency cap engine that computes a plurality of frequency cap constraints for a plurality of impression pools of a plurality of advertisement impressions to satisfy a plurality of requests for a plurality of advertisement placements on a plurality of display properties;
an allocation and pricing optimizer operably coupled to the frequency cap engine that allocates a plurality of advertisement impressions from the plurality of impression pools by maximizing an objective function with a plurality of constraints, including a plurality of supply constraints, a plurality of demand constraints, and the plurality of frequency cap constraints; and
a storage operably coupled to the frequency cap engine that stores the plurality of impression pools and the plurality of requests for the plurality of advertisement placements on the plurality of display properties.

2. The system of claim 1 wherein the plurality of requests for the plurality of advertisement placements on the plurality of display properties comprises a plurality of frequency caps that each indicate a limit to a number of times an advertisement impression of the plurality of advertisement impressions may be displayed to a unique user to satisfy a request of the plurality of requests for the plurality of advertisement placements on the plurality of display properties.

3. A computer-readable medium having computer-executable components comprising the system of claim 1.

4. A computer-implemented method for allocating online advertising, comprising:
receiving a plurality of impression pools of a plurality of advertisement impressions;
receiving a plurality of requests for a plurality of advertisement placements on a plurality of display properties;
obtaining a plurality of frequency caps that each indicate a limit to a number of times an advertisement impression of the plurality of advertisement impressions may be displayed to a unique user to satisfy a request of the plurality of requests for the plurality of advertisement placements on the plurality of display properties;
allocating advertisement impressions from the plurality of impression pools by maximizing an objective function with a plurality of constraints, including a plurality of supply constraints, a plurality of demand constraints, and a plurality of frequency cap constraints; and
outputting an allocation of advertisement impressions for each of the plurality of impression pools of the plurality of advertisement impressions for the plurality of requests for the plurality of advertisement placements on the plurality of display properties.

5. The method of claim 4 further comprising obtaining a value for each of the plurality of impression pools of the plurality of advertisement impressions.

6. The method of claim 4 further comprising receiving a frequency for each advertisement impression of the plurality of advertisement impressions that indicates a number of times the advertisement impression was displayed to the unique user to satisfy the request of the plurality of requests for the plurality of advertisement placements on the plurality of display properties.

7. The method of claim 6 further comprising computing the plurality of frequency cap constraints for each of the plurality of impression pools of the plurality of advertisement impressions to satisfy the plurality of requests for the plurality of advertisement placements on the plurality of display properties.

8. The method of claim 7 wherein computing the plurality of frequency cap constraints for each of the plurality of impression pools of the plurality of advertisement impressions to satisfy the plurality of requests for the plurality of advertisement placements on the plurality of display properties comprises receiving an arrival rate of the plurality of unique users to the plurality of display properties.

9. The method of claim 8 further comprising receiving a departure rate of the plurality of unique users leaving the plurality of display properties.

10. The method of claim 9 further comprising generating a model to compute a plurality of upper bounds for the plurality of frequency cap constraints for each of the plurality of impression pools of the plurality of advertisement impressions to satisfy the plurality of requests for the plurality of advertisement placements on the plurality of display properties.

11. The method of claim 10 further comprising computing the plurality of upper bounds for the plurality of frequency cap constraints for each of the plurality of impression pools of the plurality of advertisement impressions to satisfy the plurality of requests for the plurality of advertisement placements on the plurality of display properties.

12. The method of claim 11 further comprising outputting the plurality of upper bounds for the plurality of frequency cap constraints for each of the plurality of impression pools of the plurality of advertisement impressions to satisfy the plurality of requests for the plurality of advertisement placements on the plurality of display properties.

13. The method of claim 7 wherein computing the plurality of frequency cap constraints for each of the plurality of impression pools of the plurality of advertisement impressions to satisfy the plurality of requests for the plurality of advertisement placements on the plurality of display properties comprises computing a deterministic upper bound for each of the plurality of impression pools of the plurality of advertisement impressions to satisfy the plurality of requests for the plurality of advertisement placements on the plurality of display properties.

14. The method of claim 7 wherein computing the plurality of frequency cap constraints for each of the plurality of impression pools of the plurality of advertisement impressions to satisfy the plurality of requests for the plurality of advertisement placements on the plurality of display properties comprises computing a stochastic upper bound using a compartmental model for each of the plurality of impression pools of the plurality of advertisement impressions to satisfy the plurality of requests for the plurality of advertisement placements on the plurality of display properties.

15. The method of claim 7 wherein computing the plurality of frequency cap constraints for each of the plurality of impression pools of the plurality of advertisement impressions to satisfy the plurality of requests for the plurality of advertisement placements on the plurality of display properties comprises iteratively solving a linearized system of a plurality of ordinary differential equations to obtain an upper bound for each of the plurality of impression pools of the plurality of advertisement impressions to satisfy the plurality of requests for the plurality of advertisement placements on the plurality of display properties.

16. A computer-readable medium having computer-executable instructions for performing the method of claim 4.

17. A computer system for allocating online advertising, comprising:
means for receiving a plurality of impression pools of a plurality of advertisement impressions;
means for receiving a plurality of requests for a plurality of advertisement placements on a plurality of display properties;
means for obtaining a plurality of frequency caps that each indicate a limit to a number of times an advertisement impression of the plurality of advertisement impressions may be displayed to a unique user to satisfy a request of the plurality of requests for the plurality of advertisement placements on the plurality of display properties;
means for computing a plurality of frequency cap constraints for the plurality of impression pools of the plurality of advertisement impressions to satisfy the plurality of requests for the plurality of advertisement placements on the plurality of display properties; and
means for outputting the plurality of frequency cap constraints for the plurality of impression pools of the plurality of advertisement impressions to satisfy the plurality of requests for the plurality of advertisement placements on the plurality of display properties.

18. The computer system of claim 17 further comprising means for allocating advertisement impressions from the plurality of impression pools by maximizing an objective function with a plurality of constraints, including a plurality of supply constraints, a plurality of demand constraints, and the plurality of frequency cap constraints; and
means for outputting an allocation of advertisement impressions for the plurality of impression pools of the plurality of advertisement impressions for the plurality of requests for the plurality of advertisement placements on the plurality of display properties.

19. The computer system of claim 17 wherein means for computing the plurality of frequency cap constraints for the plurality of impression pools of the plurality of advertisement impressions to satisfy the plurality of requests for the plurality of advertisement placements on the plurality of display properties comprises means for computing a deterministic upper bound for each of the plurality of impression pools of the plurality of advertisement impressions to satisfy the plurality of requests for the plurality of advertisement placements on the plurality of display properties.

20. The computer system of claim 17 wherein means for computing the plurality of frequency cap constraints for the plurality of impression pools of the plurality of advertisement impressions to satisfy the plurality of requests for the plurality of advertisement placements on the plurality of display properties comprises means for computing a stochastic upper bound generated by a compartmental model for each of the plurality of impression pools of the plurality of advertisement impressions to satisfy the plurality of requests for the plurality of advertisement placements on the plurality of display properties.
